(19) United States
(12) Patent Application Publication
(10) Pub. No.: US 2012/0118044 A1
(43) Pub. Date: May 17, 2012

(54) METHOD AND SYSTEM FOR MANAGING A POLLUTION-PREVENTION FACILITY

(75) Inventors: II Hwan Choi, Daejon (KR); Han Soo Kim, Daejon (KR); Sun Tae Kim, Daejon (KR); Ik Jae Lee, Daejon (KR)

(73) Assignee: SCIENTEC LAB CENTER CO., LTD., Daejon (KR)

(21) Appl. No.: 13/381,376

(22) PCT Filed: Dec. 3, 2009
(86) PCT No.: PCT/KR09/07179

§ 371 Date: Dec. 29, 2011

(30) Foreign Application Priority Data
Jun. 30, 2009 (KR) 10-2009-0059180
Oct. 22, 2009 (KR) 10-2009-0100501

(51) Int. Cl. G01N 7/00

(52) U.S. Cl. 73/31.03

(57) ABSTRACT

There are disclosed a method for managing a pollution prevention facility and a system for effectively managing the pollution prevention facility which can exhaust pollutants, and a system thereof. A method for managing a pollution prevention facility includes a first measuring step of measuring pollutants before a pollution prevention facility treats a pollutant outlet; a second measuring step of measuring the amount of pollutants after the pollution prevention facility treats the pollutant outlet; and a managing step of managing an exchange period of a filling material provided in the pollution prevention facility.

### TECHNICAL FIELD

The present invention may relate to a method for managing a pollution prevention facility and a system thereof, more particularly, to a system for effectively managing the pollution-prevention facility which can exhaust pollutants, and a system thereof.

### BACKGROUND

Recently, a pollution prevention facility is a facility for eliminating or reducing exhausted atmospheric pollutants. The pollution preventing facility is designated by the Ministry of Environment as a facility, a machine, a device and the other objects structured to exhaust the atmospheric pollutant to the atmosphere. A facility for reducing or eliminating pollutant that is generated in such an exhaustion facility may be refer to an atmospheric-pollution prevention facility, which is by Article II of Korean Environmental Protection Law and article VI of Korean Enforcement Regulations.

The atmospheric-pollution-prevention facility may be categorized into a gravity dust collecting facility, an inertial dust collecting facility, a centrifugal dust collecting facility (multi cyclone type), a washing dust collecting facility, a bag filter dust collecting facility, an electric dust collecting facility, a sonic dust collecting facility, an absorption type facility, an adsorption type facility, representative thermal oxidizer type facility, a catalysis type facility, a condensation facility, a soil microorganism treatment facility. Also, the pollution prevention facility may include mechanisms and devices such as a device for collecting an atmospheric pollutant, a pipe way to pass the atmospheric pollutant there through, a ventilator to blow the atmospheric pollutant.

As mentioned above, the atmospheric pollution prevention facility may use the absorption, the adsorption and the filtering to prevent the atmospheric pollution and it may require various filling materials. Such a filling material might be the reason polluting the atmosphere by exposed atmospheric pollutant, because prevention efficiency is degraded in case too many atmospheric pollutants are absorbed and adsorbed, and the filling material might generate direct civil complaint about bad smell filed by city and surrounding area residents.

To prevent such dangers, conventional pollution prevention facilities have been using a method of replacing an old filling material when a preset usage period passes. However, the replaced old filling material still has a prevention ability and this is the reason of waste expense.

In addition, it is difficult for an environmental officer in charge of facility management to check hundreds of facilities one by one. As a result, it is substantially difficult to manage and observe the facilities and this will be a disadvantage of the conventional prevention facility.

### DISCLOSURE

### Technical Problem

To solve the problems, the embodiments may provide a method for managing a pollution prevention facility that can recognize a time point of exchanging a filling material in real time to prevent waste of expense and that can efficiently manage the pollution prevention facility at a long distance, and a system for managing the same.

### Technical Solution

To achieve the object and other advantages and in accordance with the purpose of the embodiments, a method for managing a pollution prevention facility includes a first measuring step of measuring pollutants before a pollution prevention facility treats a pollutant outlet; a second measuring step of measuring the amount of pollutants after the pollution prevention facility treats the pollutant outlet; and a managing step of managing an exchange period of a filling material provided in the pollution prevention facility.

In another aspect of the present invention, a system for managing a pollution prevention facility includes a first pollution measuring device configured to measure a pollutant material before a pollution prevention facility treats a pollutant outlet; a second pollution measuring device configured to measure a pollutant material after the pollution prevention facility treats the pollutant outlet; and a management server configured to monitor a state of the pollution prevention facility to notify the result of the monitoring to a user.

Here, the management server may include an outlet hole pollution monitoring part configured to notify to a manager the result of the measurement, if the concentration measured in the second pollution measuring device is a preset value or more.

The management server may further include a filling material exchange timing alarming part configured to alarm to the manager the difference between the values in the first pollution measuring device and the second pollution measuring device, if the difference is a preset value or less.

Each of the first pollution measuring device and the second pollution measuring device may include a dust filter configured to filter dust from the pollutants; a moisture eliminating device configured to eliminate the moisture from the pollutants; a detecting sensor array comprising a plurality of pollutant detecting sensors installed on a path where the pollutants pass after passing the dust filter and the moisture eliminating device; and a data processor configured to process values measured in the detecting sensor array to transmit the treated data to the management server.

The detecting sensor array may include an electro-chemical sensor. The electro-chemical sensor may be installed at a bent point of a path.

An auxiliary path configured to suck fresh air therein may be provided at an entrance of the detecting sensor array.

### Advantageous Effects

According to the embodiments mentioned above may have following advantageous effects.

First of all, the concentration of the pollutant before the pollution prevention facility eliminates the pollutant and the concentration of the pollutant after it eliminates the pollutant may be acquired. As a result, it may be easily checked whether the pollution prevention facility is operating normally.

Furthermore, the system for managing the pollution prevention facility may enable a manager to conveniently determine whether to exhaust the pollutants and an exchange timing of the filling material via the management server, without visiting a work spot in person.

### BRIEF DESCRIPTION OF THE DRAWINGS

FIG. 1 is a block view illustrating a structure of a system for managing an pollution prevention facility according to an embodiment;

FIG. 2 is a block view schematically illustrating inner structures of a first pollution measuring device and a second pollution measuring device shown in FIG. 1;

FIG. 3 is a diagram schematically illustrating a position where a second detecting sensor shown in FIG. 2 is installed;

FIG. 4 is a diagram schematically illustrating a position where a third detecting sensor shown in FIG. 2 is installed;

FIG. 5 is a time-based graph illustrating output of the second sensor;

FIG. 6 is a sensor chromatogram graph of FIG. 5; and

FIG. 7 is a graph illustrating integration of the sensor chromatogram graph of FIG. 6

**Numeral references for key parts shown in the drawings**
100a: First Pollution Measuring Device, 10: Pollutant Outlet
20: Pollution Prevention Facility, 100b: Second Pollution Measuring Device
200: Management Server, 210: Pollution Outlet Pollution Monitoring part
220: Filling Material Exchange Timing Alarming Part, 110: Dust filter
120: Moisture Eliminating Device, 101: Path
131˜139: Detecting Sensor, 130: Detecting Sensor Array
140: Data Processor

### BEST MODE

As follows, an exemplary embodiment of the present invention will be described in reference to the accompanying drawings.

Here, detailed description of well-known functions or configurations will be omitted not to distract a point of the present invention when describing the embodiment.

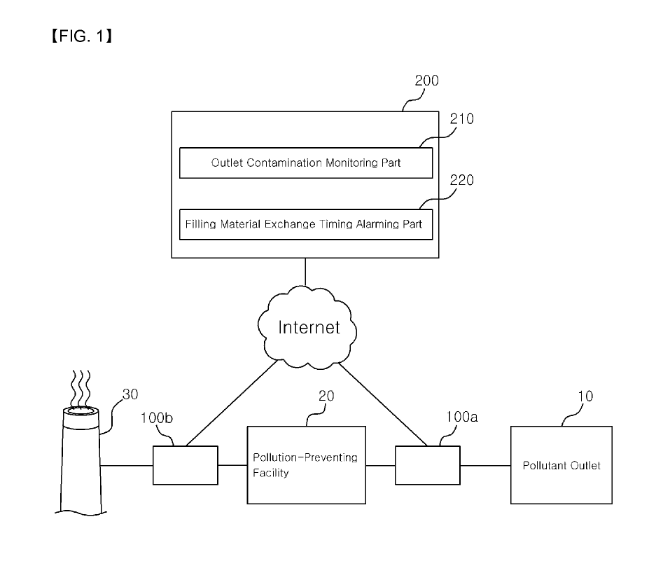

FIG. 1 is a block view illustrating a structure of a system for managing a pollution prevention facility (hereinafter, an air pollution prevention facility managing system) according to an embodiment.

The pollution prevention facility managing system according to this embodiment may include a first pollution measuring device 100a configured to measure a pollutant material before a pollution prevention facility 20 treats a pollutant outlet 10, a second pollution measuring device 100b configured to measure a pollutant material after the treatment of the pollution prevention facility for the pollutant outlet, and a management server configured to monitor a state of the pollution prevention facility to notify the result of the monitoring to a user.

The first pollution measuring device 100a may be installed between the pollutant outlet 10 and the pollution prevention facility 20 and the second pollution measuring device 100b may be installed between the pollution prevention facility 20 and an outlet hole 30. As a result, a concentration of a pollutant material before a pollutant material is eliminated by the pollution prevention facility 20 and a concentration of the pollutant material after the pollutant material is eliminated by the pollution prevention facility 20 may be acquired, to check whether the pollution prevention facility is operating normally.

The management server may include an outlet hole pollution monitoring part 210 configured to notify to a manager the result of the measurement, if the concentration measured in the second pollution measuring device 100b is a preset value or more, and a filling material exchange timing alarming part 220 configured to alarm to the manager the difference between the values in the first pollution measuring device 100a and the second pollution measuring device 100b, if the difference is a preset value or less.

As mentioned above, there may be an advantage that the manager may determine whether to exhaust the pollutant materials and an exchange timing of the filling material via the management server conveniently, without visiting a work spot in person.

The outlet pollution monitoring part 210 may notify to the manager that the concentration of the pollutant material exhausted to the atmosphere directly is a preset value or more, and it may prevent the polluted air from being exhausted to the atmosphere.

Also, the filling material exchange timing alarming part 220 may notify the efficiency of the pollution prevention facility. It may measure the concentrations of the pollutant before and after treatment of the pollution prevention facility 20. When the difference between the concentrations is a preset value or less, it may indicate that the pollution prevention facility is not operating normally and the filling material exchange alarming part 220 may alarm the abnormal operation of the facility to the manager to enable the manage to replacing the old filling material.

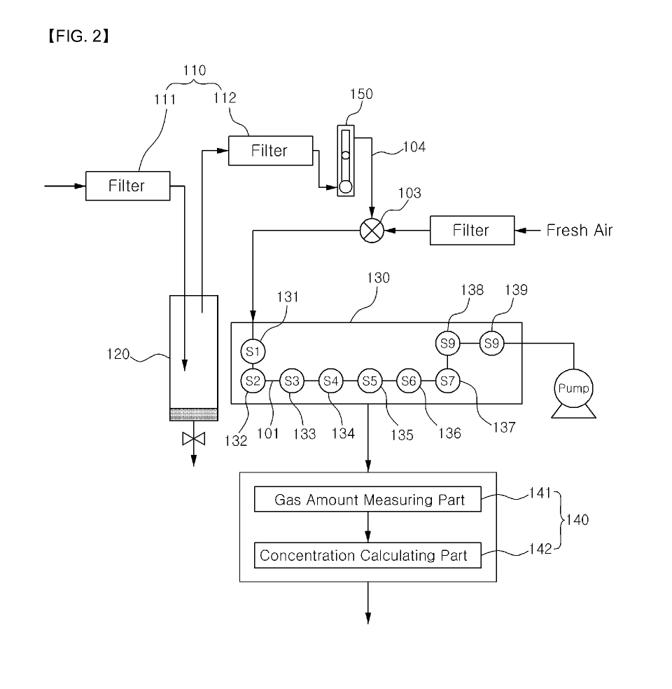

FIG. 2 is a block view schematically illustrating the inner structures of the first and second pollution measuring devices 100a and 100b.

Each of the first pollution measuring device 100a and the second pollution measuring device 100b may include a dust filter 110 configured to filter dust from the pollutant, a moisture eliminating device 120 configured to eliminate the moisture from the pollutant, a detecting sensor array 130 having a plurality of pollutant detecting sensors 131˜139 installed on a path 101 where the pollutant passes after passing the dust filter 110 and the moisture eliminating device 120, and a data processor 140 configured to process values measured in the detecting sensor array 130 to transmit the treated data to the management server.

The dust filter 110 may include a first dust filter 111 and a second dust filter 112 installed in front of and behind the moisture eliminating device 120, respectively. The moisture eliminated by the moisture eliminating device 120 may be exhausted to external air by an electro-valve.

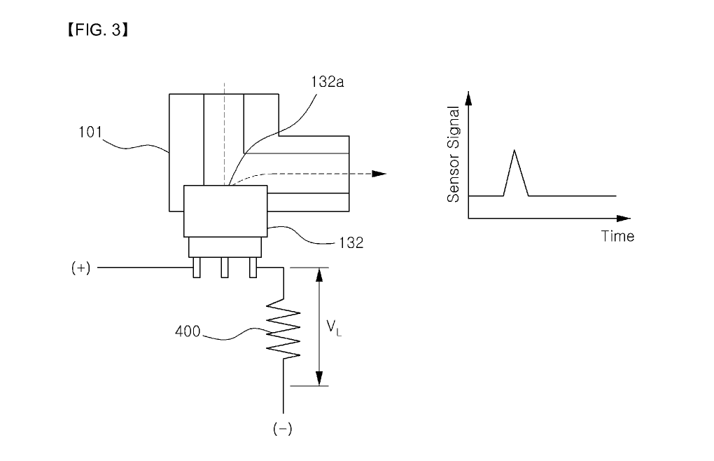

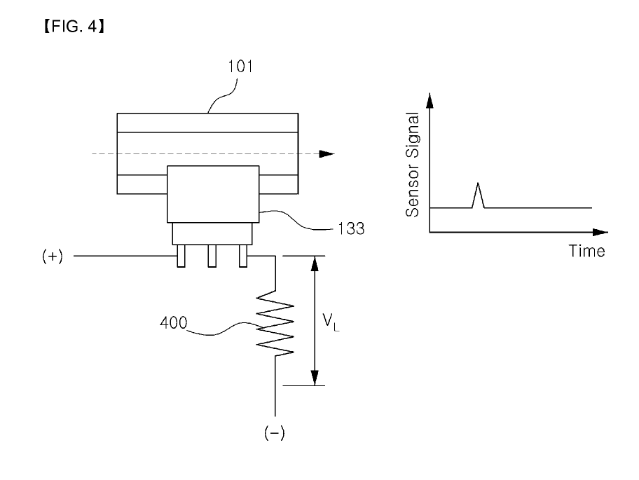

The detecting sensor array may include the plurality of the detecting sensors 131˜139. The detecting sensors 131˜139 may be semiconductor gas sensors, electrochemical sensors and optical sensors. Second, seventh and eighth detecting sensors 132, 137 and 138 may be electro-chemical sensors. The electro-chemical sensors 132, 137 and 138 may be installed a bent point of the path, only to increase sensing efficiency. In other words, as shown in FIG. 3, the electro-chemical sensor 132 may be arranged at the bent point of the path 101 and a sensing surface 132a of the sensor may be located perpendicular to the flow of fluid. The electro-chemical sensor 132 may have higher sensing efficiency when arranged perpendicular to the flow of the fluid as shown in FIG. 4 than when arranged in parallel to the flow of the fluid.

An auxiliary path 102 may be formed at an entrance of the detecting sensor array to suck fresh air therein. A valve 103 capable of selectively supplying air may be installed at a point where the path 104 having the polluted air sucked therein and the path 102 having the fresh air sucked therein. Because of that, the polluted air may be measured and fresh air may be supplied after that such that the sensors may be cleaned and stabilized and that the measuring accuracy of the sensors may be maintained and a life span of the sensors.

A flow rate meter 150 configured to measure a flow rate may be provided at the path 104 having the polluted air sucked therein or the path 101 of the sensor array 101.

The data processor 140 may include a gas amount measuring part 141 detachably installed at the detecting sensors to calculate the amount of gas based on the values measured from the detecting sensors and a concentration calculating part 142 configured to calculate the concentration of the gas based on the amount of the gas measured by the gas amount measuring part 141.

After calculating a fluctuation rate (S) of the measured value with respect to time, the gas amount measuring part 141 may calculate an area value (A) from integrating an area of the fluctuation rate (S) to calculate the amount of the absorbed-desorbed gas, which will be described in detail later when a method for managing a pollution prevention facility is described.

The concentration calculating part may extract concentration of the measured gas based on a characteristic relation between the absorption amount and the measured gas. The absorption of a plurality of measured gas samples may be measured and the characteristic relation may be acquired based on regression analysis applied to the absorption amount and concentrations of the gas samples. This will be described in detail later when a method for managing a pollution prevention facility is described.

A method for managing a pollution prevention facility, using the pollution prevention facility managing system may include a first measuring step of measuring pollutants before a pollution prevention facility treats a pollutant outlet, a second measuring step of measuring the amount of pollutants after the pollution prevention facility treats the pollutant outlet, and a managing step of managing an exchange period of a filling material provided in the pollution prevention facility.

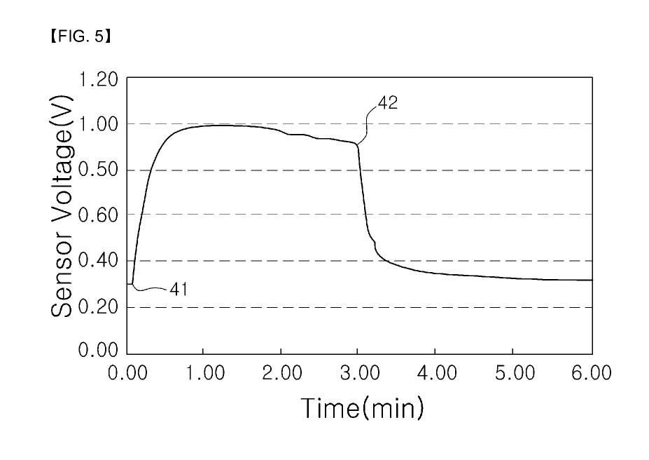

Each of the first measuring step and the second measuring step may include a step of introducing the pollutants to detecting senses 131˜139, a step of acquiring a time-based output graph (FIG. 5) by measuring an output voltage (VL) of both terminals of a load resistance 400 connected with the detecting senses 131˜139 in serial or an internal resistance of the detecting senses 131˜139 (hereinafter, the output voltage and the internal resistance will be referenced to as ‘the measured value’), a step of calculating the absorption amount of the gas from the time-based output graph, and a step of extracting concentration of gas, using the absorption amount calculated in the step of calculating the absorption amount of the gas.

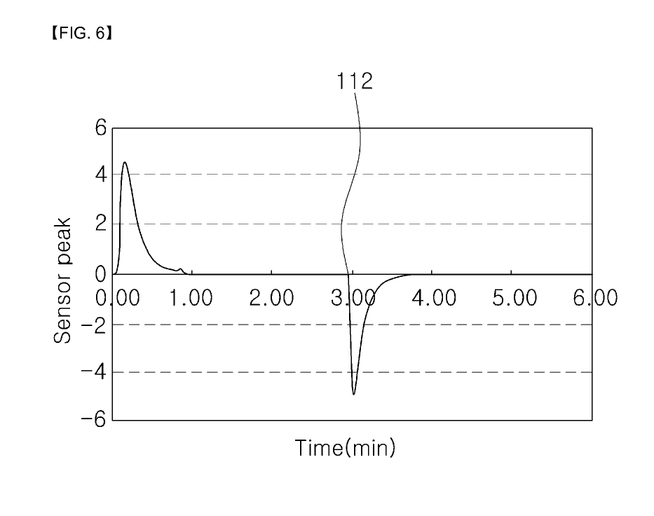

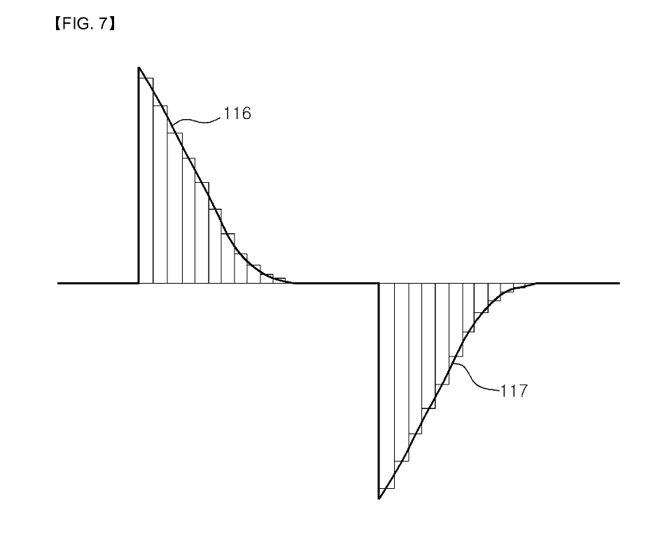

The step of calculating the gas absorption amount may include a step of calculating a fluctuation rate with respect to time of the measured value (FIG. 6) and a step of calculating an area value (FIG. 7) from integration of the area of the fluctuation rate.

The step of calculating the fluctuation rate with respect to time of the output voltage may be represented as a time-based graph as shown in FIG. 6 after calculating a gradient of time-based output voltage graph (FIG. 5).

The step of calculating the area value may calculate a value from integrating an area of the graph shown in FIG. 6. The calculation as shown in FIG. 7 may be referenced to as ‘sensor chromatogram area extraction’.

Following tables are showing values measured based on conventional voltage comparison of H₂S having various concentrations and values measured based on the sensor chromatogram area extraction according to the embodiment.

TABLE 1
Object Gas: H₂S 1 ppm, Sensor Model: MICS
5521 (Manufactured by E2V, Swiss)

| Category | Base (Vair) | Max(Vgas) | Vgas/Vair | Sout Area |
|---|---|---|---|---|
| 1^{st} | 1.57 | 2.10 | 1.34 | 50.4 |
| 2^{nd} | 1.59 | 2.09 | 1.31 | 49.6 |
| 3^{rd} | 1.62 | 2.08 | 1.28 | 50.5 |
| Average | 1.59 | 2.09 | 1.31 | 50.17 |
| Standard | 0.03 | 0.01 | 0.03 | 0.49 |
| Deviation | | | | |
| (S.D) | | | | |
| Relative | 1.58 | 0.48 | 2.05 | 0.98 |
| Standard | | | | |
| Deviation | | | | |
| (% RSD) | | | | |

‘Vair’ shown in Table 1 may refer to an output voltage of a sensor exposed to odorless air and ‘Vgas’ may refer to an output voltage of a sensor exposed to an object gas. ‘Sour_area’ may refer to a value extracted based on the sensor chromatogram area extraction (hereinafter, identical wording thereafter).

TABLE 2
Object Gas: H₂S 5 ppm, Sensor Model: MICS
5521 (Manufactured by E2V, Swiss)

| Category | Base (Vair) | Max(Vgas) | Vgas/Vair | Sout Area |
|---|---|---|---|---|
| 1^{st} | 1.53 | 2.69 | 1.76 | 103.9 |
| 2^{nd} | 1.60 | 2.55 | 1.59 | 106.7 |
| 3^{rd} | 1.65 | 2.41 | 1.46 | 103.0 |
| Average | 1.59 | 2.55 | 1.60 | 104.53 |
| Standard | 0.06 | 0.14 | 0.15 | 1.93 |
| Deviation | | | | |
| (S.D) | | | | |
| Relative | 3.78 | 5.49 | 9.29 | 1.85 |
| Standard | | | | |
| Deviation | | | | |
| (% RSD) | | | | |

TABLE 3
Object Gas: H₂S 10 ppm, Sensor Model:
MICS 5521 (Manufactured by E2V, Swiss)

| Category | Base (Vair) | Max(Vgas) | Vgas/Vair | Sout Area |
|---|---|---|---|---|
| 1^{st} | 1.54 | 2.81 | 1.82 | 133.8 |
| 2^{nd} | 1.67 | 2.71 | 1.62 | 129.8 |
| 3^{rd} | 1.76 | 2.67 | 1.52 | 129.4 |
| Average | 1.66 | 2.73 | 1.68 | 131.00 |
| Standard | 0.11 | 0.07 | 0.16 | 2.43 |
| Deviation | | | | |
| (S.D) | | | | |
| Relative | 6.68 | 2.64 | 9.45 | 1.86 |
| Standard | | | | |
| Deviation | | | | |
| (% RSD) | | | | |

TABLE 4
Object Gas: H₂S 1 ppm, Sensor Model: TGS
2602 (Manufactured by Figaro, Japan)

| Category | Base (Vair) | Max(Vgas) | Vgas/Vair | Sout Area |
|---|---|---|---|---|
| 1^{st} | 1.42 | 2.19 | 1.54 | 65.2 |
| 2^{nd} | 1.44 | 2.10 | 1.46 | 68.4 |
| 3^{rd} | 1.44 | 2.07 | 1.44 | 64.1 |
| Average | 1.43 | 2.12 | 1.48 | 65.90 |
| Standard | 0.01 | 0.06 | 0.06 | 2.23 |
| Deviation | | | | |
| (S.D) | | | | |
| Relative | 0.81 | 2.95 | 3.75 | 3.39 |
| Standard | | | | |
| Deviation | | | | |
| (% RSD) | | | | |

TABLE 5
Object Gas: H₂S 5 ppm, Sensor Model: TGS
2602 (Manufactured by Figaro, Japan)

| Category | Base (Vair) | Max(Vgas) | Vgas/Vair | Sout Area |
|---|---|---|---|---|
| 1^{st} | 1.43 | 2.95 | 2.06 | 152.7 |
| 2^{nd} | 1.48 | 2.94 | 1.99 | 150.5 |
| 3^{rd} | 1.59 | 2.92 | 1.84 | 144.4 |
| Average | 1.50 | 2.94 | 1.96 | 149.20 |
| Standard | 0.08 | 0.02 | 0.12 | 4.30 |
| Deviation | | | | |
| (S.D) | | | | |
| Relative | 5.46 | 0.52 | 5.87 | 2.88 |
| Standard | | | | |
| Deviation | | | | |
| (% RSD) | | | | |

TABLE 6
Object Gas: H₂S 10 ppm, Sensor Model: TGS
2602 (Manufactured by Figaro, Japan)

| Category | Base (Vair) | Max(Vgas) | Vgas/Vair | Sout Area |
|---|---|---|---|---|
| 1^{st} | 1.55 | 3.48 | 2.25 | 206.9 |
| 2^{nd} | 1.65 | 3.55 | 2.15 | 204.6 |
| 3^{rd} | 1.76 | 3.40 | 1.93 | 201.7 |
| Average | 1.65 | 3.48 | 2.11 | 204.40 |
| Standard | 0.11 | 0.08 | 0.16 | 2.61 |
| Deviation | | | | |
| (S.D) | | | | |
| Relative | 6.35 | 2.16 | 7.62 | 1.27 |
| Standard | | | | |
| Deviation | | | | |
| (% RSD) | | | | |

As shown in Table 1 to 6, according to the conventional voltage measuring method, an initial ‘Vair’ value may be varied as the measuring frequency is repeated and the relative standard deviation may be increasing as the concentration of the measured gas is getting higher.

In contrast, according to the sensor chromatogram area extracting method, the relative standard deviation is low even with the increased concentration and the increased repetition frequency. As a result, the sensor chromatogram area extracting method may have an advantage of good representation.

The step of extracting the concentration of gas may include a step of extracting the concentration of the measured gas based on a characteristic relation between the absorption amount and the concentration of the measured gas. The characteristic relation may be acquired from regression analysis performed between the absorption amount and the concentrations of the gas samples after measuring the absorption amount of a plurality of measured gas samples. This method is well-known knowledge in experimental statistics and detailed description thereof will be omitted accordingly.

Here, there may be further provided a odorless air injecting step of injecting odorless air before injecting the measured gas to the detecting sensors 131˜139. Typically, a small amount of gas is absorbed to a surface of a sensor that is exposed to the atmosphere. If the measured gas is injected in this state, the sensitivity of the sensor might be deteriorated and it is difficult to acquire a desired characteristic graph disadvantageously. However, according to the present invention, the odorless air injecting step may be performed before the measured gas is injected and the gas attached to the sensor may be eliminated advantageously. In addition, when the odorless air is injected, the sensor chromatogram may be extracted and the amount of the gas detached from the surface of the sensor may be measured. As a result, there may be an advantage of reverse-operating a pollution level of normal air.

A time period of injecting the odorless air in the odorless air injecting step may be longer than a time period of injecting the measured gas in the introducing the measured gas.

In other words, the time period of injecting the odorless air may be longer than the time period of injecting the measured gas. Because of that, the sensitivity of the sensor with respect to the measured gas may be enhanced. That is, if the measured gas is injected to the sensor for a relatively long time, the amount of the gas attached to the surface of the sensor might be increased and the characteristic of the sensor might be changed. As a result, the odorless air may be injected for a relatively long time and the measured gas may be injected when there is no increase or decrease of the gas amount at the surface of the sensor. There may be an advantage of gaining a precise measured value.

In the meanwhile, there may be further provided a step (a point referenced to as a numeral number ‘42’) of injecting odorless air to the detecting sensors 131˜139, a step (after ‘42’ of FIG. 5) of acquiring a time-based output graph by measuring measured values of the detecting sensors 131˜139 during the time period of injecting the odorless air, a step (‘112 of FIG. 6 and ‘117’ of FIG. 7) of calculating the desorption amount of the gas from the time-based output graph, and a step of determining a state of the detecting sensors 131˜139 based on the result of comparison between the absorption amount of the gas acquired in the step of calculating the absorption amount of the gas and the desorption amount of the gas calculated in the step of calculating the desorption amount of the gas.

The step of calculating the desorption amount of the gas may include a step (‘112’ of FIG. 6) of calculating a time-based fluctuation rate of the measured value and a step (‘117’ of FIG. 7) of calculating an area value gained from integration of an area of the fluctuation rate.

In other words, the measured gas may be injected and the odorless air may be injected after that, to calculate the desorption amount of the gas attached to the sensor.

The step of determining the state of the detecting sensors 131˜139 may compare the absorption amount and the desorption amount with each other and it may evaluate the performance of the detecting sensors 131˜139. In other words, when a different between the absorption amount and the desorption amount of the gas at the surface of the detecting sensors 131˜139 is maintained to be less than 3%, it may mean that the absorption-desorption of the gas at the surface of the detecting sensors 131˜139 may be performed reversibly and it may be determined that the gas detecting sensors are operating normally. When the difference between the absorption amount and the desorption amount is more than 3 to 5%, it may mean that the gas absorbed to the detecting sensors is not detached there from. The difference of more than 3 to 5% may be used as an indicator representing the detecting sensors cannot be used as sensors any more or an indicator for an exchange timing of the filter filtering the odorless air and for pollution of an inner pipe.

Although embodiments have been described with reference to a number of illustrative embodiments thereof, it should be understood that numerous other modifications and embodiments can be devised by those skilled in the art that will fall within the spirit and scope of the principles of this disclosure.

1. A method for managing a pollution prevention facility comprising:
a first measuring step of measuring pollutants before a pollution prevention facility treats a pollutant outlet;
a second measuring step of measuring the amount of pollutants after the pollution prevention facility treats the pollutant outlet; and
a managing step of managing an exchange period of a filling material provided in the pollution prevention facility.

2. The method for managing the pollution prevention facility according to claim 1, wherein each of the first measuring step and the second measuring step comprises,
a step of introducing the pollutants to detecting senses;
a step of acquiring a time-based output graph by measuring an output voltage at both terminals of a load resistance connected with the detecting senses in serial or an internal resistance of the detecting senses (hereinafter, the output voltage and the internal resistance will be referenced to as ‘the measured value’);
a step of calculating the absorption amount of the gas from the time-based output graph; and
a step of extracting concentration of gas, using the desorption amount calculated in the step of calculating the absorption amount of the gas.

3. The method for managing the pollution prevention facility according to claim 2, further comprising:
an odorless air injecting step of injecting odorless air before injecting measured gas to the detecting sensors.

4. The method for managing the pollution prevention facility according to claim 3, wherein the time period of injecting the odorless air in the odorless air injecting step is longer than the time period of injecting the measured gas.

5. The method for managing the pollution prevention facility according to claim 2, further comprising:
a step of injecting odorless air to the detecting sensors;
a step of acquiring a time-based output graph by measuring values measured in the detecting sensors during the time period of injecting the odorless air;
a step of calculating the desorption amount of the gas based on the time-based output graph; and
a step of determining a state of the detecting sensors based on the result of comparison between the absorption amount of the gas acquired in the step of calculating the absorption amount of the gas and the desorption amount of the gas calculated in the step of calculating the desorption amount of the gas.

6. The method for managing the pollution prevention facility according to one of claim 2, wherein the step of calculating the absorption amount of the gas comprises,
a step of calculating a time-based fluctuation rate of the measured value; and
a step of calculating an area value from integration of the area of the fluctuation rate.

7. The method for managing the pollution prevention facility according to claim 5, wherein the step of calculating the desorption amount of the gas comprises,
a step of calculating a time-based fluctuation rate of the measured value; and
a step of calculating an area value from integration of the area of the fluctuation rate.

8. The method for managing the pollution prevention facility according to one of claim 2, wherein the step of extracting the concentration of the gas comprises,
a step of extracting the concentration of the measured gas based on a characteristic relation between the absorption amount and the concentration of the measured gas.

9. The method for managing the pollution prevention facility according to claim 8, wherein the characteristic relation is acquired based on regression analysis performed between the absorption amount and concentrations of gas samples after measuring the absorption amount of measured gas samples.

10. A system for managing a pollution prevention facility comprising:
a first pollution measuring device configured to measure a pollutant material before a pollution prevention facility treats a pollutant outlet;
a second pollution measuring device configured to measure a pollutant material after the pollution prevention facility treats the pollutant outlet; and
a management server configured to monitor a state of the pollution prevention facility to notify the result of the monitoring to a user.

11. The system for managing the pollution prevention facility according to claim 10, wherein the management server comprises,
an outlet hole pollution monitoring part configured to notify to a manager the result of the measurement, if the concentration measured in the second pollution measuring device is a preset value or more.

12. The system for managing the pollution prevention facility according to claim 10, wherein the management server further comprises,
a filling material exchange timing alarming part configured to alarm to the manager the difference between the values in the first pollution measuring device and the second pollution measuring device, if the difference is a preset value or less.

13. (canceled)

14. The system for managing the pollution prevention facility according to one of claim 10, wherein each of the first pollution measuring device and the second pollution measuring device comprise,
a dust filter configured to filter dust from the pollutants;
a moisture eliminating device configured to eliminate the moisture from the pollutants;
a detecting sensor array comprising a plurality of pollutant detecting sensors installed on a path where the pollutants pass after passing the dust filter and the moisture eliminating device; and
a data processor configured to process values measured in the detecting sensor array to transmit the treated data to the management server.

15. The system for managing the pollution prevention facility according to one of claim 14, wherein the detecting sensor array comprises an electro-chemical sensor.

16. The system for managing the pollution prevention facility according to claim 15, wherein the electro-chemical sensor is installed at a bent point of a path.

17. The system for managing the pollution prevention facility according to claim 15, wherein an auxiliary path configured to suck fresh air therein is provided at an entrance of the detecting sensor array.

18. The system for managing the pollution prevention facility according to claim 14, wherein the data processor comprises,
a gas amount measuring part detachably installed at the detecting sensors to calculate the amount of gas based on the values measured by the detecting sensors; and
a concentration calculating part configured to calculate the concentration of the gas based on the amount of the gas measured by the gas amount measuring part.

19. The system for managing the pollution prevention facility according to claim 18, wherein the gas amount measuring part calculates a time-based fluctuation rate (S) of the measured value and then calculates the amount of the gas absorbed and desorbed based on an area value (A) of integrated area of the fluctuation rate (S).

20. The system for managing the pollution prevention facility according to claim 18, wherein the concentration calculating part extracts the concentration of the measured gas based on a characteristic relation between the absorption amount and the concentration of the measured gas.

21. The system for managing the pollution prevention facility according to claim 20, wherein the characteristic relation is acquired based on regression analysis performed between the absorption amount and concentrations of gas samples after measuring the absorption amount of measured gas samples.
